(19) United States
(12) Patent Application Publication
(10) Pub. No.: US 2013/0339253 A1
(43) Pub. Date: Dec. 19, 2013

(54) Mobile Device Based Financial Transaction System

(71) Applicant: Dan Moshe Sincai, Tel Aviv (IL)

(72) Inventor: Dan Moshe Sincai, Tel Aviv (IL)

(21) Appl. No.: 13/594,914

(22) Filed: Aug. 27, 2012

Related U.S. Application Data
(60) Provisional application No. 61/529,448, filed on Aug. 31, 2011.

(51) Int. Cl. G06Q 20/32

(52) U.S. Cl. CPC G06Q 20/3227
USPC 705/71; 705/44; 705/21; 705/14.51; 705/14.27; 705/14.15

(57) ABSTRACT

A system and method for conducting financial transactions by means of a smartphone is disclosed. A barcode is printed on the invoice, which is scanned by the mobile device screen. The mobile device is used instead of a credit card or cash. Provisions for data security, transaction verification, and communications protocols are disclosed.

### BACKGROUND

1. Technical Field

Embodiments of the present invention relate generally to systems and methods for conducting financial transactions by use of smartphones or other digital means.

2. Description of Related Art

The use of payment cards (credit, debit and prepaid) instead of cash has become a common phenomenon in most developed countries. In addition, the use of cards in general has become a common means for identifying the cardholder and exchanging value in a variety of commercial applications (e.g. loyalty cards, gift cards).

However the said payment cards have limited security features and lacks computation means, limiting their utility. Thus certain alternatives have arisen. For example Near Field Communication devices allow transactions to be made by means of a smartphone, without cash or credit card. However these systems require hardware modifications to be introduced both at the Point of Sale (PoS) and at the user device.

In addition, the above mentioned payment cards coupled with other exiting payment means such as cash and coupons makes for a plethora of payment means which the user is required to carry at all times—encumbering the customer.

Hence, an improved method for financial transactions, which replaces all of the above mentioned payment means, by use of mobile devices and not requiring any dedicated hardware fulfills a long felt need.

### BRIEF SUMMARY

According to an aspect of the present invention, there is provided a system and method for conducting financial transactions by means of a mobile device (e.g. smartphone).

### System Brief

An aspect of the present invention provides a system for conducting a wireless financial transaction comprising:
means for capturing one or more identifying feature of an output issued for said transaction;
means for communicating said one or more identifying feature of said output;
means for receiving said one or more identifying feature of said output;
means for receiving information of said output issued for said transaction;
means for correlating said one or more identifying feature with said information of said output;
means for communicating said information of said output and requesting authorization for said output; and optionally
means for receiving authorization for said output.

In still another embodiment of the invention, said means for communicating said one or more identifying feature is a mobile device.

In one embodiment of the invention, said means for capturing said one or more identifying feature of said output is optical means.

In still another embodiment of the invention, said optical means is activated by said mobile device.

In still another embodiment of the invention, said optical means is a digital camera, said camera is incorporated into said mobile device.

In still another embodiment of the invention, said means for receiving said one or more identifying feature of said output is a server, said server is a remote server from said mobile device.

In still another embodiment of the invention, said server is incorporated into said mobile device.

In still another embodiment of the invention, said means for communicating said information of said output and requesting authorization communicates said information and request of authorization to a Point of Sale, said Point of Sale communicates said information and request of authorization to a clearing house.

In still another embodiment of the invention, said means for communicating said information and requesting authorization of said output communicates said information and request directly to a clearing house.

In still another embodiment of the invention, said output is in printed-paper or on-screen form.

In still another embodiment of the invention, said one or more identifying feature comprises but not limited to one or more of a transaction code, PoS identifier, cashier identifier, list of purchases, total amount to be paid, or any other information that can be used to uniquely identify the transaction.

In a further aspect of the invention, said system further comprising means for validating said means for communicating said one or more identifying feature of said output, preferably said means for communicating said identifying feature is a mobile device.

In a further aspect of the invention, said system further comprising means for authenticating said means for communicating said one or more identifying feature of said output.

In a further aspect of the invention, said system further comprising means for registering said means for communicating said one or more identifying feature of said output.

### Method Brief

In yet another aspect the invention provides a method for conducting a financial transaction using a mobile device comprising:
capturing one or more identifying feature of a output issued for said transaction;
communicating said one or more identifying feature of said output;
receiving said one or more identifying feature of said output;
receiving information of said output issued for said transaction;
correlating said one or more identifying feature with said information of said output;
communicating said information of said output and requesting confirmation for said output; and
receiving authorization for said output.

In one embodiment of the invention, said method further comprising validating said means for communicating said one or more identifying feature of said output.

In one embodiment of the invention, said method further comprising registering said means for communicating said one or more identifying feature of said output.

In a particular embodiment the present invention provides a system for conducting a financial transaction using a mobile device comprising:
A software application in electronic communication with said mobile device and a point of sale;
means for validation of the user and hardware of said mobile device;
means for optical capturing a transaction code from PoS by said mobile device 501;
means for retrieving the payment means from the said mobile device;
means for requesting authorization of said financial transaction from a clearing house or by way of point of sale;

In yet another particular embodiment the invention comprising means for carrying out a step of registering said device.

It is further within provision of the invention wherein said PIN in addition with device related data produce the secret key for information encryption

It is further within provision of the invention further comprising means for selecting a preferred payment means and supplying payment means details.

It is further within provision of the invention wherein said step of selecting a preferred payment means is performed automatically based on criteria selected from the group consisting of charge date; line of credit; available promotions/discounts; or any other user-defined hierarchy.

It is further within provision of the invention wherein said payment means are selected from the group comprising: credit account; debit account; prepaid account; bank account; loyalty cards; coupons.

It is further within provision of the invention wherein further allowing said user to choose between said payment means.

It is further within provision of the invention wherein said payment means details are not stored on any central location, such as the system servers.

It is further within provision of the invention wherein said payment means details are not stored on any location in their entirety in any usable form. For, example, a first proper subset of the digits of the credit card number is stored on the mobile device while a second non-identical proper subset of the digits of the credit card number is stored on the server, where the union of said first set and said second set contains the entirety of said credit card number.

It is further within provision of the invention wherein said payment means details are stored in their entirety on the mobile device.

It is further within provision of the invention wherein said payment means details are stored in their entirety on the system servers.

It is further within provision of the invention wherein said payment means' physical presence is not required for carrying out said method.

It is further within provision of the invention wherein said payment means details, such as: card number, card owner ID, expiration date, and card specific data such as CCV2 in case of credit cards, are stored in encrypted form based on user select PIN.

It is further within provision of the invention implementing pre-paid payment means wherein businesses can issue digital pre-paid cards to users of said method by means of said mobile device.

It is further within provision of the invention wherein businesses can refund users of said method by means of said mobile device.

It is further within provision of the invention implementing loyalty/member club platform wherein businesses can publish club related commercial information to users of said method by means of said mobile device.

It is further within provision of the invention implementing customer club platform wherein business can issue “digital member cards” and sell coupons to users of said method by means of said mobile device.

It is further within provision of the invention implementing advertising wherein advertisers display advertisements to users of said method by means of said mobile device.

It is further within provision of the invention wherein said advertisements include elements selected from the group consisting of: text, audio, video, interactive items.

It is further within provision of the invention implementing commercial social networking wherein users may participate in activities entailing benefits to them or other users. This may take place, for example, by participating in the distribution of or sharing benefits and discounts. Selected but not limiting examples are: coupon sharing and exchanging; discount information sharing and exchanging; join club invitation, system invitation bonuses; providing feedback to merchant (e.g. service level); gift card sharing or granting to another user; exchange of benefits such as exchange between coupons of prepaid cards of different retails.

It is further within provision of the invention further allowing users of said system to invite others to use said system.

It is further within provision of the invention further allowing users of said system to invite others to a member club.

It is further within provision of the invention further allowing said users of said mobile devices to share/exchange discounts and coupons.

It is further within provision of the invention wherein said discounts are targeted by demographic.

It is further within provision of the invention further allowing users of said system to transfer credit, coupons, rechargeable cards, money, discounts and the like amongst themselves.

It is further within provision of the invention allowing users of said system to make group payments shared between several users of said system.

It is further within provision of the invention allowing users of said system to split payments between several users of said system.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a possible block diagram of credit card payment authorization architecture in the prior art;

FIG. 2 illustrates a flow diagram for authorization, batching, clearing and funding of credit card transactions in the prior art;

FIG. 3 illustrates a possible embodiment of the sequence diagram for the enrolment process

FIG. 4 shows a possible embodiment of the invention's data flow;

FIG. 5 shows yet another possible embodiment of the invention's data flow;

FIG. 6 illustrates a possible embodiment of the sequence diagram for the payment process

FIGS. 7A-I illustrates possible embodiments of the user interface implementing a part of the inventive method.

FIG. 8 displays a possible business model related to the invention.

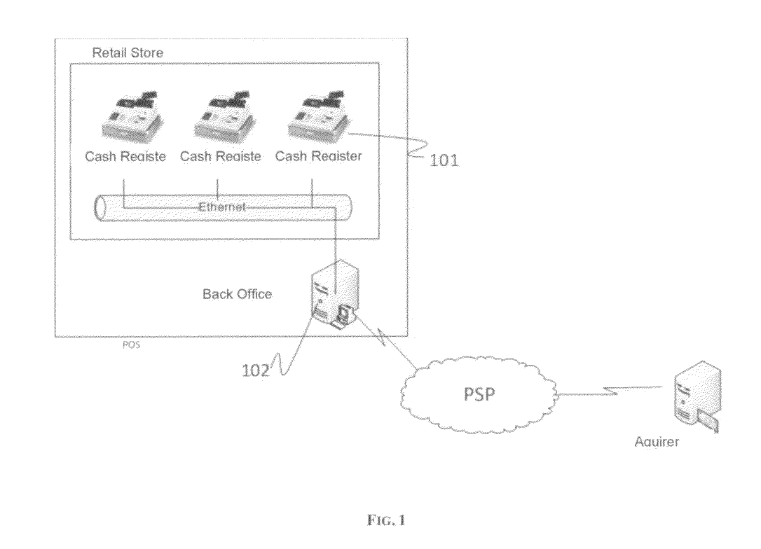

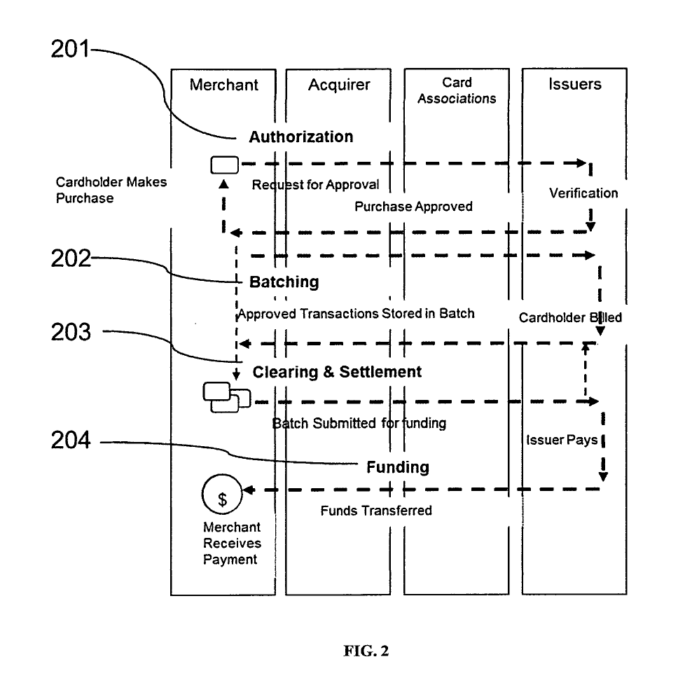

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for conducting wireless financial transaction as claimed in the appended claims.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in one or more embodiment of the invention.

### TERMS AND ABBREVIATIONS

The term ‘payment card’ or ‘card’ or ‘payment means’ refers hereinafter to a credit card, debit card, pre-paid card, gift card, loyalty card, coupons, tickets or any other form of exchange of value that allows the bearer to transfer money, render payment, and receive services, products or the like.

The term ‘Payment’ refers hereinafter to any use of the following means: a credit card, a gift card, a club/loyalty card, a ticket, a coupon or any other form of exchange of value.

The term ‘Card Association’ refers hereinafter to a network such as VISA®, MasterCard®, Discover® (and others) that act as gateways between the acquirer and issuer for authorizing, exchanging value and funding transactions.

The term ‘cardholder’ refers hereinafter to the owner of a card or payment mean used to make a purchase.

The term ‘Merchant’ refers hereinafter to the business or other entity accepting payments for products or services sold to a cardholder.

The term ‘issuer’ refers hereinafter to a financial institution or other organization that issues a payment means or any other form of exchange of value to the cardholder.

The terms ‘acquiring bank’ or ‘acquirer’ or ‘clearing house’ refers hereinafter to a financial institution that authorizes the payments for products or services on behalf of a merchant.

The term ‘authorization’ of a transaction refers hereinafter to the process where the acquirer verifies the available funds of cardholder and accepts/denys the payment on behalf of a merchant. The authorization process usually doesn't involve exchange of money but only the exchange of data only.

The term ‘settlement’ refers hereinafter to the actual exchange of funds between the cardholder's issuer and the merchant occurring after payment.

The term ‘financial transaction’ refers hereinafter to any interchange in financial assets and liabilities between economic entities.

The term ‘mobile device’ refers hereinafter to any device having communication and computation means, including cellphones, mobile phones, smartphones, PDAs, laptops, tablet computers, and the like.

The term ‘Phone’ refers hereinafter to means for communicating one or more identifying feature of output issued for a transaction. In one particular example, the term ‘Phone’ refers to a ‘mobile device’ as described above.

The term ‘PoS’ refers hereinafter to a Point of Sale system, e.g. a cash register and/or an entire environment required for making a financial transaction including real or virtual retailer. In one particular example, the PoS is capable of processing financial transactions, for example by means of a connection to an acquirer, or by means of connection to a backend server connected to an acquirer.

The term ‘plurality’ refers hereinafter to any positive integer (e.g, 1, 5, or 10).

The term ‘HMAC’ refers hereinafter to Hash-based Message Authentication Code, this comprising any standard hash algorithm like MD5 or SHA-256 secured by password.

The term ‘PCI-DSS’ refers hereinafter to Payment Card Industry (PCI) Data Security standard.

The term ‘S/N’ refers hereinafter to Serial Number.

The invention provides a complete solution for using a mobile device for making financial transactions, often called ‘e-cash’, ‘electronic wallet’ or the like. The method in effect replaces many commonly used wallet contents, including:
Cash
Credit cards
Pre-Paid cards
Refund Certificates
Loyalty cards
Gift certificates
Coupons
Tickets

As opposed to other existing cashless, card-less transaction solutions (such as Near Field Communication devices), the inventive solution does not require any hardware modifications to be introduced at the Point of Sale (PoS) and does not require any dedicated hardware other than a mobile device (with a camera) and a standard PoS.

The following sections provide a high level overview of the method, starting with a brief description of how the aforementioned processes are accomplished in a regular PoS environment, and then explaining the inventive concept through an example use-case.

### PRIOR ART DESCRIPTION

The following section describes a common payment architecture often found in retail stores and the flow of data once a transaction is made.

Most retail establishments use a cash register 101 which is connected electronically, via the data network, to at least one acquirer and possibly to 3^{rd} party systems (such as loyalty club management). In case of more than one cash register, usually they all connect to a back-office server (or PoS provider) 102 which acts as a hub for all financial transactions initiated at the cash register and provides, among other services, accounting, logistics and loyalty programs management. In addition, the server may act as a gateway to the Payments Service Provider (PSP) or to the acquiring bank.

### Merchant Credit Card Processing

The following describes an example of the actions currently taken once a customer makes a payment with a credit card at a PoS. The flow of information and money between the cardholder and the merchant involves the following parties: Cardholder, Merchant (by way of PoS), Acquirer, Card association and Issuer.

When a customer (cardholder) pays for physical goods or services with a credit card, the card information is recorded by the merchant's PoS. The credit card information (including inter alia card ID#, cardholder name, signature, expiry date, security code, and the like) can be recorded either by magnetic swipe or manual input. In the first case the magnetic stripe is read-off which includes, among other encoded data, the Card Verification Value (CVV)—possession of which ensures that the card was present at the POS and was swiped (this data is invisible to the cardholder). In the second case, the credit data is typed in by the business which may include the Card Verification Value 2 (CVV2) which is printed, most of the times on the backside of the card. This data again testifies to the fact that the card is physically in the position of the cardholder.

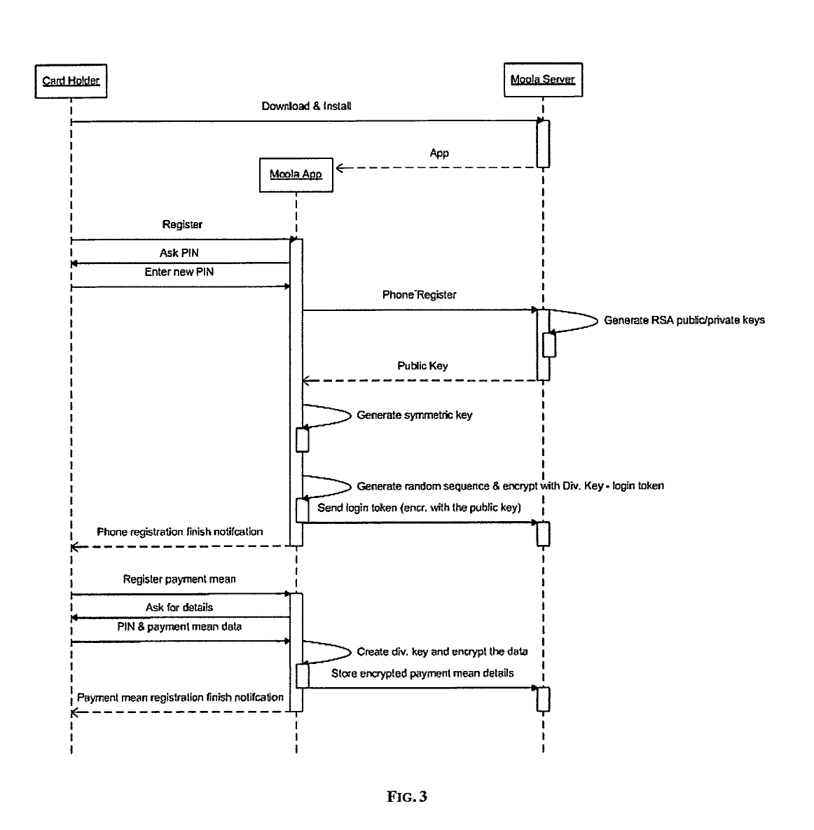

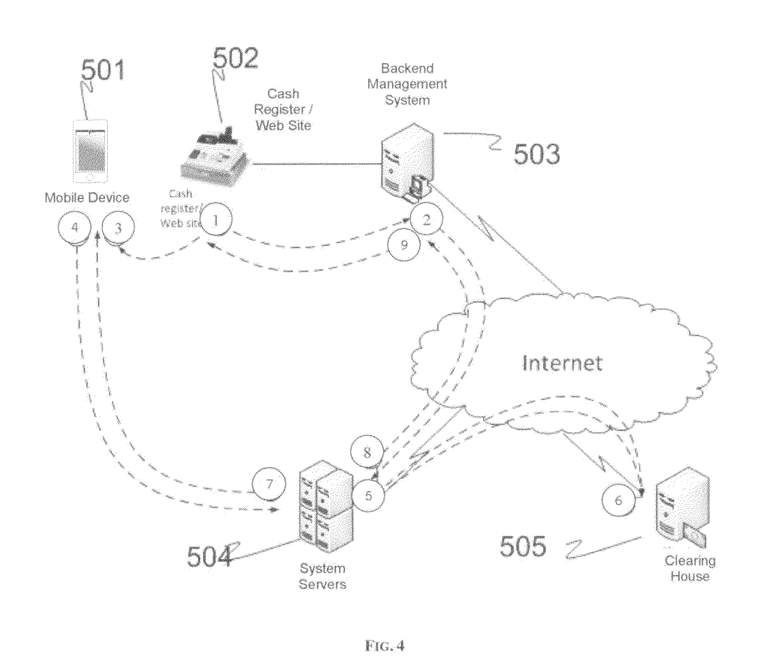

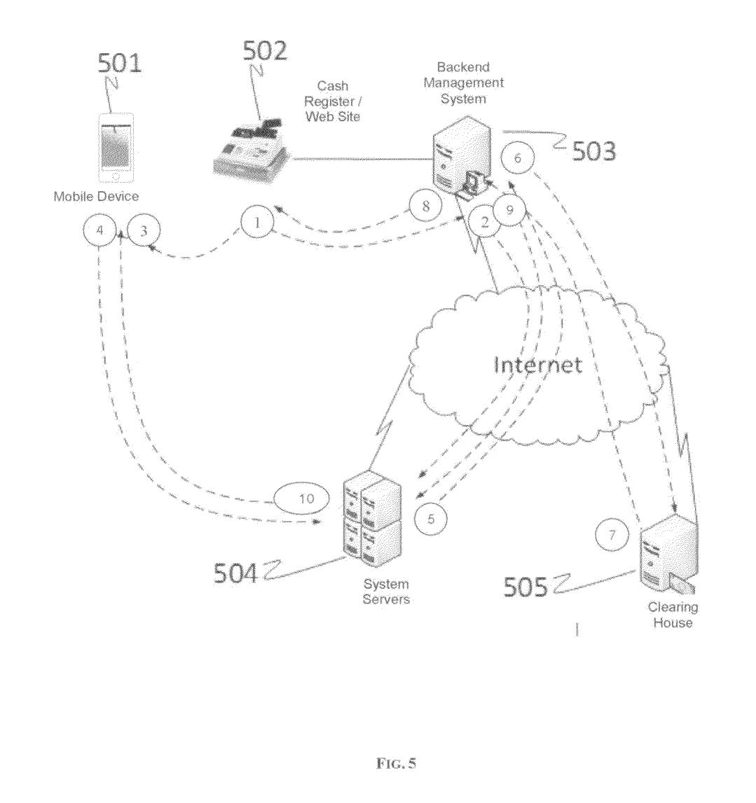

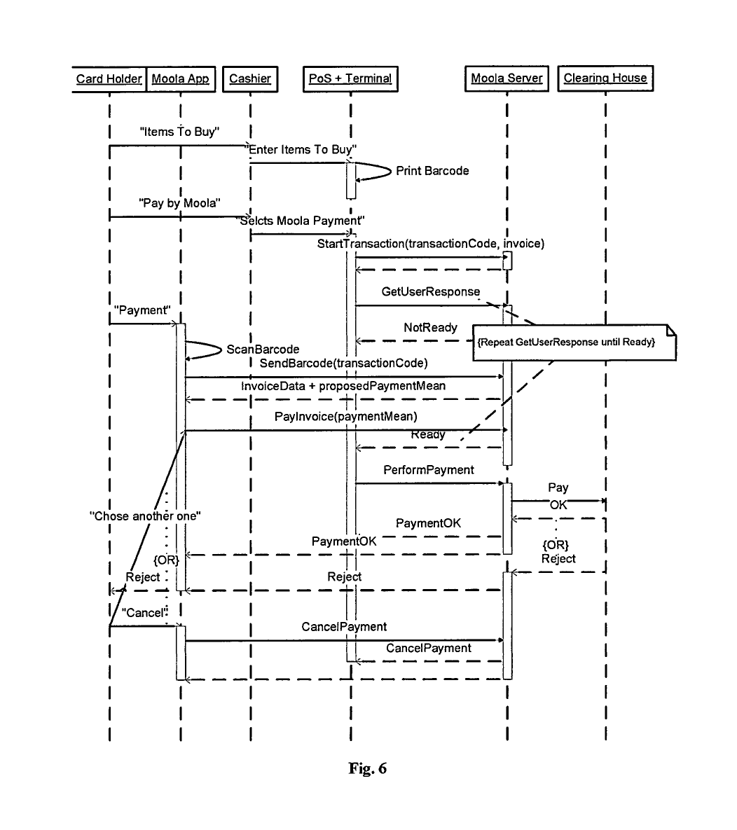

After the credit card has been submitted to the PoS, the following interactions take place between the merchant and the issuer (see FIG. 2).

### Authorization 201

The PoS submits the transaction to the acquirer. The acquirer verifies with the issuer that the card number and transaction amount are both valid. If the card number and/or amount are not valid the transaction is denied.

### Batching 202

If the transaction is authorized it is then stored in a batch, which the merchant sends to the acquirer later to receive payment (usually at the end of the day).

### Clearing and Settlement 203

The acquirer sends the transactions in the batch through the card association, which debits the issuers for payment and credits the acquirer. In effect, the issuers pay the acquirer for the transactions.

### Funding 204

Once the acquirer has been paid, the merchant receives payment. The amount the merchant receives is equal to the transaction amount minus the discount rate, which is the fee the merchant pays the acquirer for processing the transaction.

The entire process, from authorization to funding, usually takes about 3 days.

In the event of a chargeback (when there's an error in processing the transaction or the cardholder disputes the transaction), the issuer returns the transaction to the acquirer for resolution. The acquirer then forwards the chargeback to the merchant, who must either accept the chargeback or contest it.

### Merchant Means for Exchange of Value Processing

Payment with alternative payment means (such as coupons, loyalty cards, etc.) usually involves the following parties:
Alternative payment mean holder: the customer holding the coupon.
Merchant: the business accepting the coupon.
Alternative payment mean issuer: the organization that issued the payment mean—may be the merchant or consumer/member club or a 3^{rd} party issuer.

When a customer pays for physical goods or a service with an alternative payment mean, the information of the payment mean is recorded by the merchant's PoS, either by manual input, by bar-code scanning, or magnetic swipe and then verified by the payment mean issuer. The verification process varies according to the identity of the said issuer. Following are a few possible scenarios:

Alternative payment mean issued by merchant: this scenario applies mostly to loyalty programs managed by the merchant, in which case the payment mean is verified by the PoS (according to a pre-defined algorithm, or list of acceptable values).

Payment mean issued by 3rd party: in this case the code is issued by 3rd party (product manufacturer, consumer club, etc.). The code is verified locally by the PoS (according to a pre-defined algorithm, or list) or by an on-line connection of the payment system to the issuer which verifies the code and sends back to the back office an approval message.

### THE INVENTION

With this overview of extant schemes in place we now turn to the inventive method using an example. This example involves the following parties:
End-user (Mobile device): a customer carrying a mobile device.
PoS: a standard point of sale system.

The method requires the following preliminary steps:
End-user Registration;
Payment means enrollment into inventive system.

The method involves a series of steps including:
End-user authentication;
Optical capture of payment code
Payment in one of the supported methods, including:
   credit
   prepaid
   coupons/gift certificates/tickets

### Preliminary Steps

### Registration

In one embodiment of the invention, when an unregistered user opens the application a registration procedure begins comprising the steps:
the application generates a cryptographic asymmetric key pair (i.e. a public and a private key), the public-private pair is used for the future authentications of the mobile device;
the said public key is sent to the system server;
the user is asked to provide a personal PIN code, based on said PIN and device specific data (e.g. IMEI number, and/or randomly generated string) a symmetric key is created;
said symmetric key is used to encrypt the said private key to be stored on the phone 501 (for protection).

In yet another embodiment of the invention, the said symmetric key is used to encrypt user sensitive data to be stored on the system's server thus creating a different key for each user. It will be appreciated by one skilled in the art that by not storing all user details with an identical symmetric key each user record needs to be “hacked” separately.

### Device Validation

In one embodiment of the invention, after the registration, the system sends back a message to the phone, bearing a validation code. This is preferably an SMS message but may be any other digital message such as an email, a chat message, a text file, or the like. The user enters the validation code in the mobile application to finish the registration.

In yet another embodiment of the invention, certain phone identification means (e.g. IMEI number) are then sent to the system together with the validation code and are used to pair the created account with the device. The system verifies the data and accepts or rejects the registration request.

In certain embodiments of the invention, the said public-private key pair, created at the registration stage, is used for the phone authentication and session identification.

### Payment Means Enrollment

Once the end-user is registered the user is able to enroll his preferred payment means. The user is allowed to register as many payment means as he/she wishes. In case of a credit card or debit card or certain prepaid cards the user provides the required payment means details (including credit card number/bank account (debit), CVV2, Id number, etc.).

In one embodiment of the invention, said enrolled payment means details are dispersed: a first proper subset of card details is stored on server 504 (e.g. 4 last digits of credit card number) while a second proper subset of card details is stored on the device (e.g. the rest of the card number), where the union of said first set and said second set contains the entirety of said payment card.

It will be appreciated by one skilled in the art, that by not storing the entire credit card number on the device, nor on the server, that the card number cannot be ‘hacked’ by stealing the phone or compromising the server. If a thief attempts to retrieve the credit card number from a stolen device, his plans are foiled since the number is not stored on the device in its entirety. Furthermore since the method requires a pin code for operation, the thief will not be able to make use or pay for items using the device. Likewise a hacker who has gained access to the plaintext of the server card number database will have access only to partial numbers.

In one embodiment, part of the user data stored on the system server 504 is encrypted by said symmetric key which was created during registration (as described in paragraph [0094]).

In one embodiment, Payment means issued by a 3^{rd} party (such as credit companies, banks, etc.) will require a validation process to determine that the user is indeed the proprietor of the account and to reduce the risk level by the clearing house.

In one embodiment of the invention the system charges the credit/bank account a small sum and adds a payment validation code to the user's billing description alternatively the system will charge/credit the user's account with a random micro sum. The user is required to fill-in said validation code or micro sum in the mobile application to validate the said account/card and gain full privileges to use the payment means.

In an alternative embodiment of the invention the user is required to swipe his credit card at any supporting PoS the PoS generates a transaction code which the users scans with his mobile device and the payment mean is paired to the account and user. In this method the entire information is read off the credit card's magnetic stripe and a hash of the said data is saved.

### Payment Process

### Log-in and Verification of User's Identity

If the customer wishes to make payment using the inventive method, he uses his mobile device (501 of FIG. 5) to login in to the system client and inputs his secret PIN number for validation of his identity.

The phone is identified by the system using a challenge request-response communication and the secret key created using said PIN and said device data. If the challenge response corresponds to the challenge request then the PIN is correct and the user is verified; otherwise the user is denied and (for instance) prompted again for the PIN, after a certain delay, and for a maximum of (for instance) three trials before being locked out of the system for a predetermined amount of time.

If successfully authenticated, Once registration is complete the payment process may begin.

### Payment

The cashier makes the standard operations required to process the purchase, e.g., inputting the selected items into the PoS 503. After all items have been entered; the cashier goes through to the payment stage and the PoS sends all the relevant payment data to the system server 504, including: amount to pay, bought items and the transaction code, PoS identifier and the deal identifier.

Depending on the of business's “operational type” there are several embodiments of communication between the PoS 503 to the system server 504: in case of a restaurant (or any other business which manages several bills simultaneously at the PoS) the PoS starts to periodically poll the system server 504 waiting to get the payment means details for the said purchase. If the purchase is paid for by a means of payment other than the invention (i.e. credit card or cash), the PoS stops polling the system servers 504. If the business handles a bill at a time (as most retails do) the PoS receives the said response immediately.

The customer uses the mobile device 501 incorporated camera to capture the transaction code. The code is sent to the system servers 504.

The transaction code may appear in several embodiments:

In one embodiment the code is generated by the PoS and printed by the cashier printer either on the bill, a dedicated note or on a screen. In this case the transaction code identifies the specific purchase and contains information such as PoS ID and invoice number.

Yet another possible embodiment is to position a unique identification sticker in a visible and accessible place on the cashier counter. In this case the transaction code identifies the specific PoS terminal (cash register).

The transaction code mentioned may be a conventional bar code, a QR code, other matrix code, or other input method known in the art and/or readable by available hardware, augmented by an alphanumeric human readable representation in proximity to the scannable code.

After the user scans the transaction code, the code is sent to the system server 504.

The system server 504 replies with an OK message to the PoS 503 for the relevant transaction code. In addition, the system server sends the relevant payment info to the mobile device 501, including: amount to pay and items purchased and the recommended payment mean.

After the end user receives the bill he may select/deselect purchased items, decide to pay just part of the sum, set additional attributes (such as tip amount, number of payments, split tab etc.) and change the payment means (which was suggested automatically by the system servers 504) and approves/denies the payment, the data is sent back to the system servers 504.

### Credit Authorization and Settlement

If the end user approved the transaction, There are several possible clearing embodiments with the invention:

In the first model presented in FIG. 4. the PoS 503 is connected to the system servers 504 (for example via a Web Service interface over HTTPS) which in turn communicate with the acquiring bank 505 (for example also via Web Service using HTTPS). In this model the system servers 504 perform the authorization process 201 vis-à-vis the acquiring bank and return it's response (approved/denied) to both the PoS 503, which sends back the response to the cashier 502, and the end-user 501. If the transaction request is denied by the acquiring bank, the end user is informed and may select a different payment mean or cancel the transaction. It the transaction is canceled by the end user the system server returns a transaction cancellation to the cash register 502 via the PoS 503.

In the second model shown in FIG. 5, the PoS is a client of both system server 504 and clearing house 505. It communicates for example via Web Services over HTTPS channel. The system servers 504 are used to retrieve the user's payment means details and send them to the PoS 503 for authorization of payment without using the system server as go-between between PoS 503 and clearing house 505.

After the transaction is concluded the customer may be required to fill in additional data such as merchant service survey, feedbacks etc.

### Prepaid Payment

In the case of a prepaid payment the system server 504 checks the current account balance of the user. If the user has sufficient funds it approves the payment, updates the amount of money in the prepaid account, stores the payment record in the database, sends back an approval to the PoS 503 and sends a notification to the user's device. Otherwise the action is canceled; the action is recorded in the database, and a denial message is sent back to the PoS along an appropriate notification that is sent to his mobile device. No interaction with an external clearing house is necessary.

### Coupon Payment

In the case of a coupon payment the system servers 504 check the items purchased by user. If the user has purchased a coupon for one or more of the purchased items the system server sends a bill (as explained in paragraph [00117]) containing the coupon as an item with positive cost (thus reducing the cost of the total amount to pay).

### Money Transfer

Along with external (standard) payment means, it is within the provision of the system to allow for the direct transfer of cash between different users of the system. In addition this feature is used for loading bonus money/points (earned during different operation with the system), money refunds, etc.

The user is permitted to use this wallet just like any other of the payment means described above.

The money in the internal money wallet can be either completely unrestricted (the user can use them anywhere he/she wants) or restricted (allowing use in specific shop networks or clubs).

### Receiving Refunds

It is within the provision of the invention to enable the customer to receive refunds and rebates as pre-paid money which is loaded directly into his pre-paid account.

The refund process is identical to the process described above in paragraphs [00107]-[00117] except for the fact that instead of charging the user's account it is reimbursed with the refunded sum. The money is loaded directly in to the user's prepaid account for the relevant merchant.

### Platform Features

### Payment Means Selection

If the user has registered more than one payment mean, it is within provision of the invention to query and/or advise the user about the payment means selection, according to certain user-selectable policies, the selection could be completely automatic. There are several predefined policies the user can select and combine:
1. Select the payment means with closest/latest payment day.
2. Select the payment means with most available credit-line (maximize obligo)
3. Select the payment means that provides the biggest discount.
4. Achieve minimum transaction number/credit usage as required by Credit Company to reduce fees.

For example, the user can build the following policy: select the card with the biggest discount for a given purchase; if there are no discounts, select the card that was least used this month; if no such card exists, select the card with latest payment day. Other scenarios are within provision of the invention, such as for instance selection of the card associated with an account having the largest balance at the time of purchase.

### Loyalty Club Platform

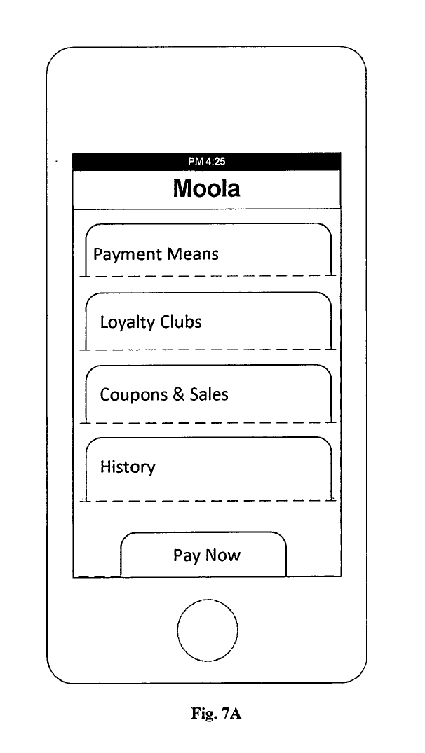

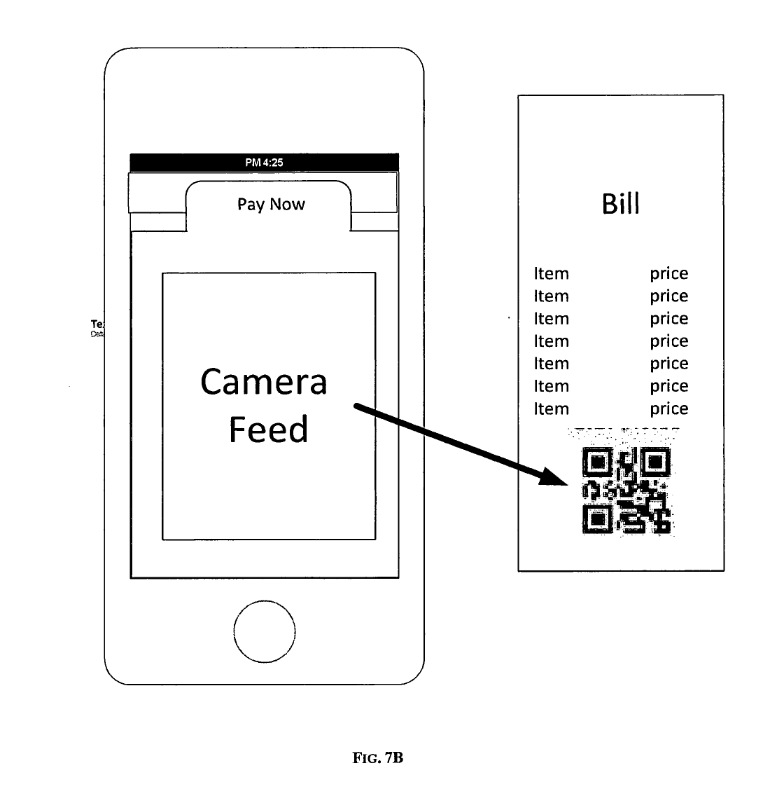

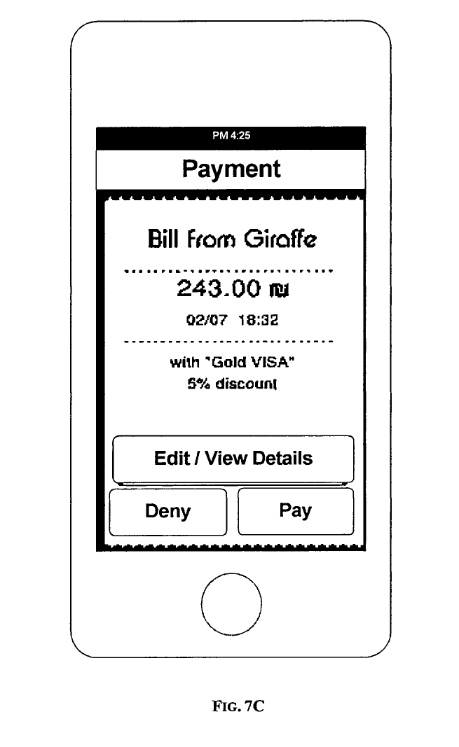

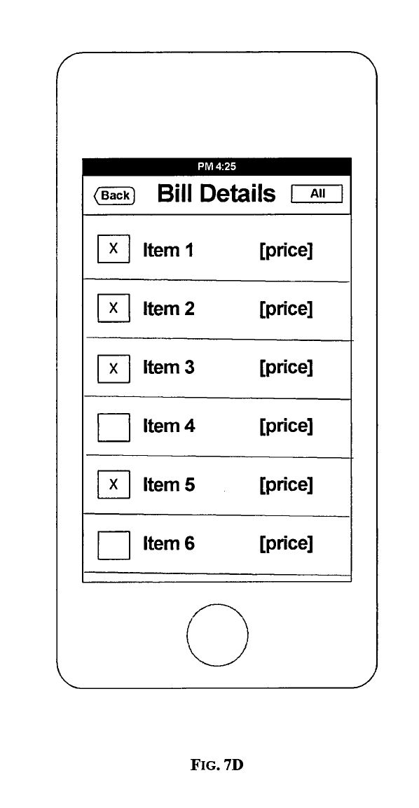

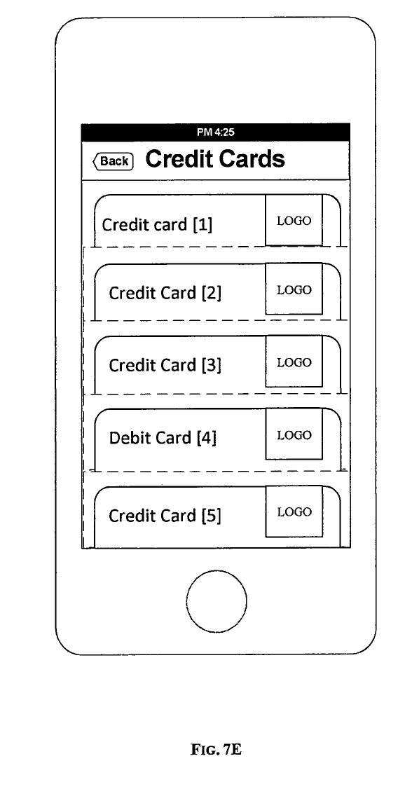

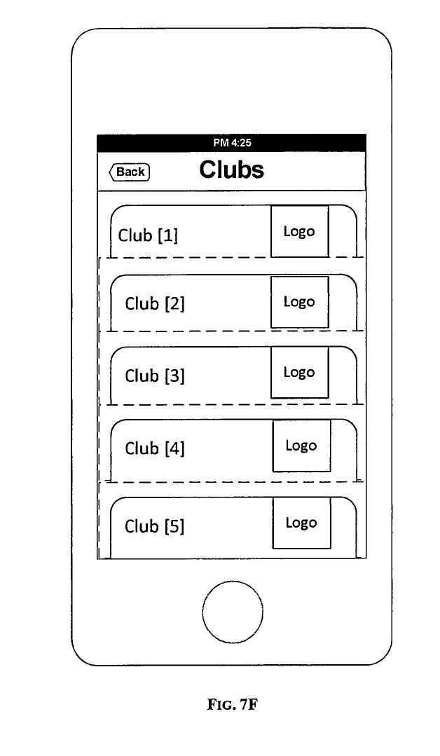

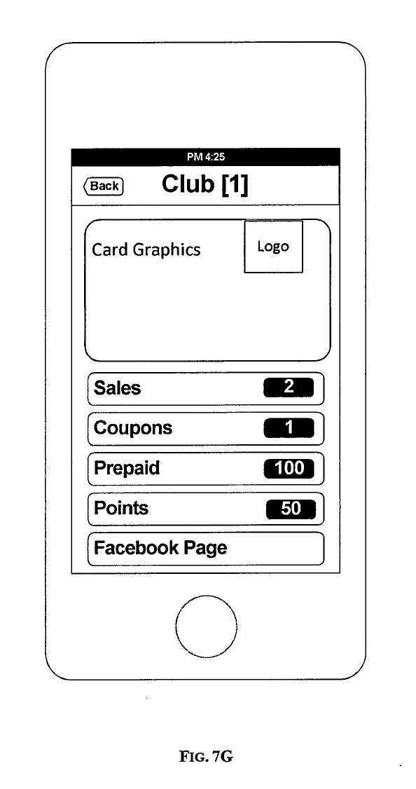

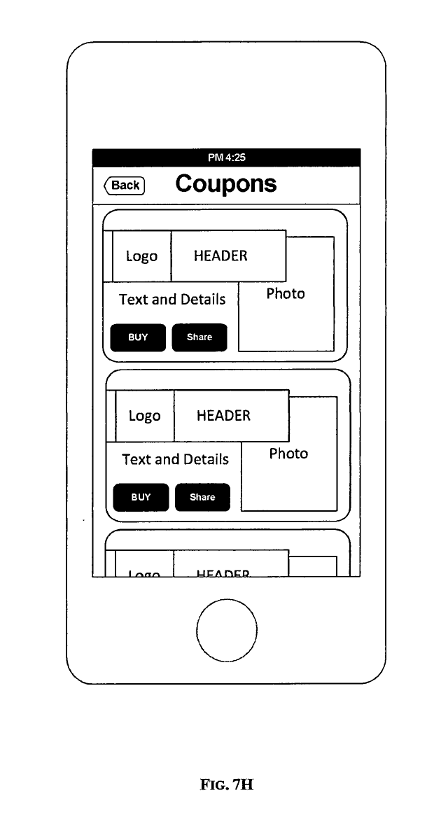

It is within provision of the invention that retailers be able to advertise their products, offer coupons, discounts and services directly to users of the inventive system and issue a digital loyalty card, as shown for example in FIGS. 7F, 7G, 7H and 7i.

In addition the inventive solution enables any of it's users to enroll to the merchants loyalty club directly from his mobile device without filling any forms. Furthermore the inventive solution enables the user to pay any membership fee directly from his mobile device.

The application provides a simple interface for any subscribed merchant to manage and add new advertisements to the end user, including sales, coupons, catalogs and the like in all mediums, including: images, video, and audio.

FIG. 7A illustrates a possible embodiment of the user interface main screen.

FIG. 7B illustrates a possible embodiment of the user interface capture QR (bill) screen.

FIG. 7C illustrates a possible embodiment of the user interface bill received notice screen.

FIG. 7D illustrates a possible embodiment of the user interface edit bill details screen.

FIG. 7E illustrates a possible embodiment of the user interface payment means page.

FIG. 7F illustrates a possible embodiment of the user interface loyalty clubs picker screen.

FIG. 7G illustrates a possible embodiment of the user interface loyalty club screen.

FIG. 7H illustrates a possible embodiment of the user interface retail issued coupons screen.

FIG. 7I illustrates a possible embodiment of the user interface prepaid top-up screen.

### Presenting Location

It is within provision of the invention to display a map presenting the users location and all shops, restaurants, and other facilities in the surroundings that are capable of using with the system. It also marks those facilities that currently have discounts for customers.

### Commercial Social Networking

The system also provides a platform for commercial social networking. This networking enables users to participate in activities entailing benefits to them or other users. This may take place, for example, by participating in the distribution of or sharing benefits and discounts. Selected but not limiting examples are: coupon sharing and exchanging; discount information sharing and exchanging; join club invitation, system invitation bonuses; providing feedback to merchant (e.g. service level); gift card sharing or granting to another user; exchange of benefits such as exchange between coupons of prepaid cards of different retails and the like as will be clear to one skilled in the art.

### Invitation to Use the System

A user of the system can initiate invitations to unregistered user to use the system. If as a result of the invitation the new user registers at the system, it is within provision of the invention that the inviter gets a money/credit/points bonus, for example credited to his internal wallet.

### Club/Discount/Promotion Invitation

The user of the system can invite other users to a ‘member club’. If as a result of the invitation the new user joins the club, it is within provision of the invention that the inviter gets a certain bonus credited for example to his internal wallet. Generally this money will be restricted to the specific club involved.

### Discount/Coupon Sharing

The user of the system can share information about his clubs, discounts and coupons, as shown for example in FIG. 7H. This figure shows an example of a user card (loyalty cards and loyalty card view), and associated discounts and coupons (retail issued coupons). Maps showing discount provider locations are also possibly displayed. It is within provision of the invention that some discounts earned by the system user can be transferred to other system users. Depending on the type of discount/coupon the user transferring it may lose it. In addition the user will be able to send an invitation to other users/unregistered users to redeem a coupon/discount—if it is redeemed the user will be credited with a bonus, such as money loaded to his wallet, increased discount and etc. Each club (entity giving a discount) decides for itself whether the discount is freely transferable (which may be used by both the sender and the receiver) or whether it is a movable discount (which can be used by a receiver only).

For example, this feature is useful for family members. The husband may have a discount for purchasing with the system in a certain retail chain. He is currently at his work and his wife is shopping. He is able to transfer the discount to her instantly, allowing her to enjoy the benefits of the discount.

### Money Transfer

It is within provision of the invention that users of the system be able to transfer money from one user's payment means to another user's account.

### Group/Split Payments

It is within provision of the invention to facilitate group and/or shared payments. For example, a user may be given the ability to select friends with whom to share the bill, receiving a unified payment code for the entire purchase. In such a case, each member will (for example) be sent an individual request to approve the Split Payment

It is within provision of the invention to facilitate split/partial payments. For example, a user may want to pay for his order from a larger bill, the user will be given a list of purchased items from which he can select the items that he wants to pay for.

### SUMMARY

Amongst the advantages of the system as herein disclosed are the following:
a. Safeties of transaction—credit details are never directly disclosed.
b. Physical cards are kept safe at home.
c. Application data are protected by PIN code.
d. Safe data transfer is assured due to digitally encrypted and/or signed transactions.
e. Resilience against data theft.
f. Convenience of payment means.
g. Use of several payment method including credit, debit and pre-paid.
h. Use of a formalized credit sum for all payment methods.
i. Benefit from all available discounts and coupons.
j. Real time notification of transactions
k. Centralized invoice management—no paper required.
l. Enables any merchant possessing standard POS equipment to quickly create and manage its own loyalty program.
m. Enables the merchant to offer a digital membership club which is always in the customer's pocket.
n. Enables the merchant to issue his own prepaid cards and coupons.
o. Enables the merchant to have direct communication with his customers and send discounts, sales and any other material directly to their phone.

It is within purview of the invention to provide a solution which interfaces to the PoS through a programming interface (API) adapted to handle all communication with the PoS, handle authentication and validation services of the system as well as end user management.

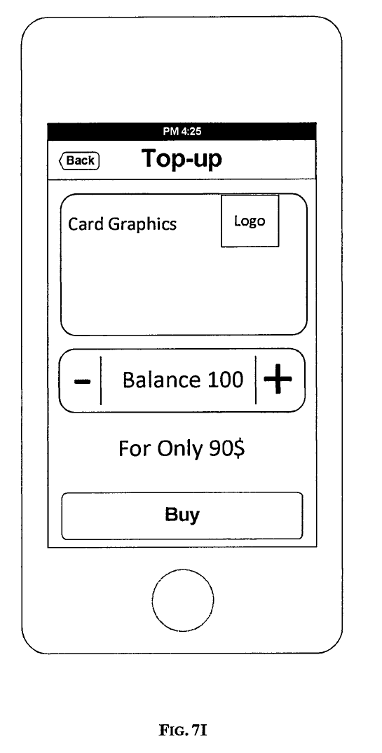

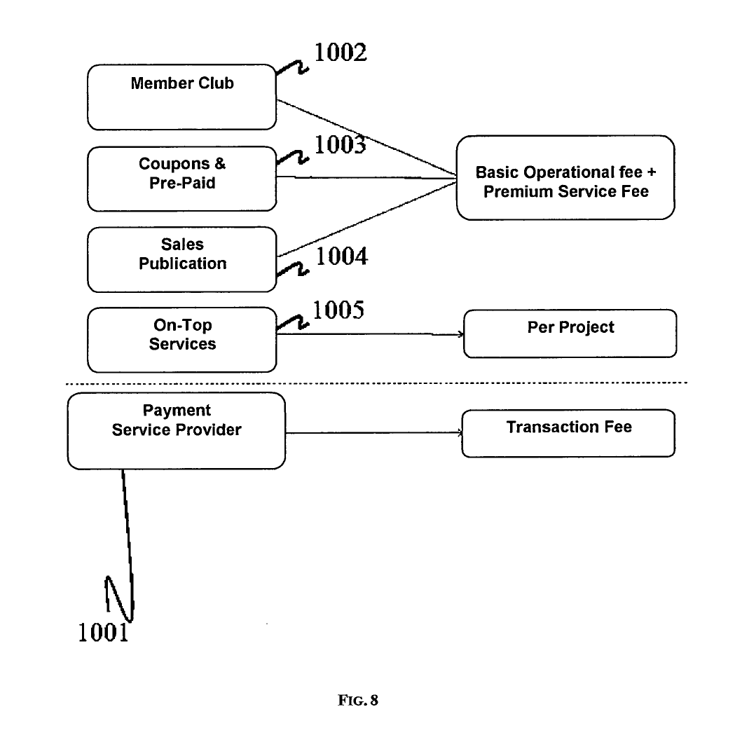

In FIG. 8 a high level business model diagram is shown. Merchants are offered a “digital member club” containing a personalized digital member card 1002 which is “always in the user's pocket”; in addition, the offering includes the capability to distribute digital coupons and prepaid account 1003 to member users of the system. Furthermore, the offing includes the ability to publish special offers in text, graphics and video 1004 to members of the merchant's club—for all the above services a fixed operational fee will be charged on a periodic base (Basic fee). A higher fee will be charged for additional services exceeding the basic package (e.g. more than a certain amount of coupons a month). In addition On-top services 1004 shell be provided to customers who require custom made services (e.g. incorporate catalog into members' card, link to web page, e-shop, etc.). Lastly, a transaction fee 1001 will be charged for each purchase make with the system.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. a system for conducting a wireless financial transaction comprising:
means for capturing at least one or more identifying feature of an output issued for said transaction;
means for communicating said at least one or more identifying feature of said output;
means for receiving said at least one or more identifying feature of said output;
means for receiving information of said output issued for said transaction;
means for correlating said at least one or more identifying feature with said information of said output;
means for communicating said information of said output and requesting authorization for said output; and optionally
means for receiving authorization for said output.

2. The system of claim 1, wherein said means for communicating said at least one or more identifying feature is a mobile device.

3. The system of claim 1, wherein said means for capturing said at least one or more identifying feature of said output is optical means.

4. The system of claim 1, wherein said optical means is activated by said mobile device.

5. The system of claim 4, wherein said optical means is a digital camera, said camera is incorporated into said mobile device.

6. The system of claim 1, wherein said means for receiving said at least one or more identifying feature of said output is a server, said server is a remote server from said mobile device.

7. The system of claim 1, wherein said server is incorporated into said mobile device.

8. The system of claim 1, wherein said means for communicating said information of said output and requesting authorization communicates said information and request of authorization to a Point of Sale, said Point of Sale communicates said information and request of authorization to a clearing house.

9. The system of claim 1, wherein said means for communicating said information and requesting authorization of said output communicates said information and request directly to a clearing house.

10. The system of claim 1, wherein said output is in printed-paper or on-screen form.

11. The system of claim 1, wherein said at least one or more identifying feature is one or more of a transaction code, PoS identifier, cashier identifier, list of purchases or total amount to be paid.

12. The system of claim 1, wherein said system further comprising means for validating said means for communicating said at least one or more identifying feature of said output, preferably said means for communicating said identifying feature is a mobile device.

13. The system of claim 1, further comprising means for validating said means for communicating said at least one or more identifying feature of said output.

14. The system of claim 1, further comprising means for registering said means for communicating said at least one or more identifying feature of said output for use, said registering comprising the steps:
requesting a PIN code from a user of said means for communicating said at least one or more identifying feature of said output;
generating a unique per user symmetric key from said PIN and an additional related data on said device for said means for communicating said at least one or more identifying feature of said output;
generation of an asymmetric key pair (private and public) by said means for communicating said at least one or more identifying feature of said output;
encryption of said private key with said symmetric key by said means for communicating said at least one or more identifying feature of said output;
sending said public key by said means for communicating said at least one or more identifying feature of said output to server;
sending a validation code to said means for communicating said at least one or more identifying feature of said output; and
entering said validation code into a mobile application running on said means for communicating said at least one or more identifying feature of said output.

15. The system of claim 14 wherein said public-private keys are used for validation of said means for communicating said at least one or more identifying feature of said output, by signing per session challenge request, where access to said private key secured by said symmetric key.

16. The system of claim 15 wherein said challenge is being changed per request.

17. The system of claim 14 wherein said entering said validation code is by requiring said user of said means for communicating said at least one or more identifying feature of said output to enter said PIN.

18. The system of claim 1 further comprising means for selecting a preferred payment means and supplying payment means details.

19. The system of claim 18 wherein selecting a preferred payment means is performed automatically based on criteria selected from the group consisting of: charge date; line of credit; available promotions; user-defined hierarchy.

20. The system of claim 18, wherein said payment means are selected from the group consisting of: credit account; debit account; prepaid account; bank account; loyalty cards; coupons.

21. The system of claim 20, further allowing said user to choose between said payment means.

22. The system of claim 1, further wherein said payment means details are not stored on said server, optionally said payment means details are stored on said means for communicating said at least one or more identifying feature of said output.

23. The system of claim 22, wherein payment card information is dispersed, a first proper subset of the information is stored on said means for communicating said at least one or more identifying feature of said output while a second proper subset of the information of the credit card number is stored on the server, where the union of said first set and said second set contains the entirety of said payment card.

24. The system of claim 22, wherein said payment card information, including: number part, card owner ID, expiration date, and CCV2 are stored in encrypted form using said PIN.

25. The system of claim 20 wherein a subset of information selected from the group consisting of: selected credit card digits; card owner; card expiration date; CCV2 number are stored on said server, while a non-identical subset of information selected from the same group is stored on said means for communicating said at least one or more identifying feature of said output.

26. The system of claim 1 further implementing advertising wherein advertisers display advertisements to users by means of said means for communicating said at least one or more identifying feature of said output.

27. The system of claim 25 wherein said advertisements include elements selected from the group consisting of: text, audio, video, interactive items.

28. The system of claim 1, further implementing mapping wherein facilities adapted for use of said system are displayed on a map by means of said means for communicating said at least one or more identifying feature of said output.

29. The system of claim 1, further implementing commercial social networking wherein users may participate in activities selected from the group consisting of: club sharing; discount information sharing; invitation bonuses; providing feedback; sending requests.

30. The system of claim 1, further allowing users of said system to invite others to use said system.

31. The system of claim 1, further allowing users of said system to invite others to a member club.

32. The system of claim 1, further allowing said users of said means for communicating said at least one or more identifying feature of said output to share discounts.

33. The system of claim 31, wherein said discounts are targeted by demographic.

34. The system of claim 1, further allowing users of said system to transfer credit, coupons, rechargeable cards, money, discounts and the like amongst themselves.

35. The system of claim 1, further allowing users of said system to make group payments shared between several users of said system.

36. A method for conducting a financial transaction using a mobile device comprising:
capturing at least one or more identifying feature of a output issued for said transaction;
communicating said at least one or more identifying feature of said output;
receiving said at least one or more identifying feature of said output;
receiving information of said output issued for said transaction;
correlating said at least one or more identifying feature with said information of said output;
communicating said information of said output and requesting confirmation for said output; and optionally
receiving authorization for said output.

37. The method of claim 36, further comprising means for registering said means for communicating said at least one or more identifying feature of said output for use, said registering comprising the steps:
requesting a PIN code from a user of said means for communicating said at least one or more identifying feature of said output;
generating a unique per user symmetric key from said PIN and an additional related data on said device for said means for communicating said at least one or more identifying feature of said output;
generation of an asymmetric key pair (private and public) by said means for communicating said at least one or more identifying feature of said output;
encryption of said private key with said symmetric key by said means for communicating said at least one or more identifying feature of said output;
sending said public key by said means for communicating said at least one or more identifying feature of said output to server.
sending a validation code to said means for communicating said at least one or more identifying feature of said output; and
entering said validation code into a mobile application running on said means for communicating said at least one or more identifying feature of said output.

38. The method of claim 37, wherein said public-private keys are used for validation of said means for communicating said at least one or more identifying feature of said output, by signing per session challenge request, where access to said private key secured by said symmetric key.

39. The method of claim 38, wherein said challenge is being changed per request.

40. The method of claim 36, further comprising authenticating said means for communicating said at least one or more identifying feature of said output comprising the steps:
validating the user and means for communicating said at least one or more identifying feature of said output;
generating a transaction code by a PoS terminal by use of said system server;
printing said transaction code, optionally as a barcode, at a point of sale terminal;
sending said transaction code to said server by way of point of sale or directly to a clearing house;
requesting authorization of said financial transaction from said clearing house; and
returning said authorization to said point of sale by way of said point of sale and server.

41. The method of claim 37, wherein said validation is by requiring said user to enter a PIN code.

42. The method of claim 36, further comprising a step of selecting a preferred payment means and supplying payment means details.

43. The method of claim 42 wherein said step of selecting a preferred payment means is performed automatically based on criteria selected from the group consisting of: charge date; line of credit; available promotions; user-defined hierarchy.

44. The method of claim 42 wherein said payment means are selected from the group consisting of: credit account; debit account; prepaid account; bank account; loyalty cards, coupons and tickets.

45. The method of claim 44, further allowing said user to choose between said payment means.

46. The method of claim 42, further wherein said payment means details are not stored on said server, optionally said payment means details are stored on said means for communicating said at least one or more identifying feature of said output.

47. The method of claim 44, wherein for the case of a credit account, a first proper subset of the digits of the credit card number is stored on means for communicating said at least one or more identifying feature of said output while a second proper subset of the digits of the credit card number is stored on the server, where the union of said first set and said second set contains the entirety of said credit card number.

48. The method of claim 44 wherein said credit card number part, card owner ID, expiration date, and CCV2 are stored in encrypted form using said PIN.

49. The method of claim 42, wherein a subset of information selected from the group consisting of: selected credit card digits; card owner; card expiration date; CCV2 number are stored on said server, while a non-identical subset of information selected from the same group is stored on said means for communicating said at least one or more identifying feature of said output.

50. The method of claim 36 further implementing advertising wherein advertisers display advertisements to users of said means for communicating said at least one or more identifying feature of said output.

51. The method of claim 49 wherein said advertisements include elements selected from the group consisting of: text, audio, video, interactive items.

52. The method of claim 36 further implementing mapping wherein facilities adapted for use of said system are displayed on a map by means for communicating said at least one or more identifying feature of said output.

53. The method of claim 36, further implementing commercial social networking wherein users may participate in activities selected from the group consisting of: club sharing; discount information sharing; invitation bonuses; providing feedback to the vendor; sending requests.

54. The method of claim 36, further allowing users of said system to invite others to use said system.

55. The method of claim 36 further allowing said users of said mobile devices to share discounts.

56. The method of claim 54, wherein said discounts are targeted by demographic.

57. The method of claim 36, further allowing users of said system to transfer credit, coupons, rechargeable cards, money, discounts and the like amongst themselves.

58. The method of claim 36, further allowing users of said system to make group payments shared between several users of said system or split bills (pay for what you ordered).

59. The method of claim 36, further wherein retailers are able to advertise their products, offer coupons, discounts and services directly to users of the inventive system and issue a digital loyalty card.

60. The method of claim 36, further enabling any its users to enroll to the merchant's loyalty club directly from their mobile device without filling any forms.

61. The method of claim 60, further enabling the users to pay any membership fee directly from their mobile devices.

62. The method of claim 36, further wherein a simple interface for any subscribed merchant is provided to manage and add new advertisements to the end user, including sales, coupons, catalogs and the like in all mediums, including: images, video, and audio.
